(19) United States
(12) Patent Application Publication
(10) Pub. No.: US 2026/0309684 A1
(43) Pub. Date: Oct. 8, 2026

(54) HIGH PRESSURE FLUID HANDLING DEVICE FOR LIQUID CHROMATOGRAPHY

(71) Applicant: IDEX HEALTH & SCIENCE, LLC, Rohnert Park, CA (US)

(72) Inventors: Daniel CZARNECKI, Bristol, CT (US); Michael KELLER, Napa, CA (US); Graham SHELVER, Concord, CA (US)

(73) Assignee: IDEX HEALTH & SCIENCE, LLC, Rohnert Park, CA (US)

(21) Appl. No.: 19/480,727

(22) PCT Filed: May 2, 2024
(86) PCT No.: PCT/US2024/027435

§ 371 Date: Oct. 31, 2025

Related U.S. Application Data
(60) Provisional application No. 63/463,413, filed on May 2, 2023.

(51) Int. Cl. G01N 30/60; B01D 15/22; G01N 30/52; G01N 30/56

(52) U.S. Cl. CPC G01N 30/606; B01D 15/22; G01N 30/56; G01N 30/6078; G01N 30/6095; G01N 2030/522; G01N 2030/562; G01N 2030/6008

(57) ABSTRACT

A high-pressure fluid handling device. The high-pressure fluid handling device includes a housing, a tube, and a stationary phase medium. The housing includes a first component with a first interface surface and a second component with a second interface surface. The first and second components are securable to one another with the first and second interface surfaces in facing relationship with one another to form an interface therebetween. The housing includes a channel extending through the first component to and along the interface. The tube extends along the channel. The tube defines a lumen with a substantially circular cross-section having a lumen diameter equal to or less than 1000 μm. The stationary phase medium is positioned in the lumen. The stationary phase medium is suitable to chromatographically separate compounds present in a liquid sample.

### CROSS-REFERENCE TO RELATED APPLICATIONS

This application claims the benefit of and priority to U.S. Provisional Application No. 63/463,413 titled “High Pressure Fluid Handling Device for Liquid Chromatography” filed May 2, 2023, the content of which being incorporated herein in its entirety.

### TECHNICAL FIELD

The subject matter disclosed herein relates to liquid chromatography systems generally, and more particularly to fluid handling devices for transporting fluids in high pressure, and ultra-high pressure liquid chromatography applications. The fluid handling device may be particularly adapted for micro and/or nano-scale chromatography applications, to provide for liquid chromatography columns that have an internal diameter equal to or less than 1000 um.

### BACKGROUND

High-performance liquid chromatography (HPLC) is a known technique for separating the constituent components of a sample. A liquid used to carry the sample through the chromatography system is referred to as the “mobile phase”. The components of the sample may be separated in a “column”, that is typically a tube packed with particulate material to which different components have varying degrees of affinity. The packing material is referred to as the “stationary phase” and is usually a silica or polymer-based medium and may be coated with chemical functionality to drive desired chemical affinity with components of the sample.

Traditional HPLC instruments typically use columns that are constructed from rigid stainless steel tubing. Other inert materials, such as various polymers are also used in the construction of chromatographic columns. Typical HPLC columns have an inner diameter in the range of about 1-10 mm, and a packed length of stationary phase in the range of about 5 -25 cm. More recently, ultra-high performance liquid chromatography (UHPLC) has found significant use for testing lower sample volumes than traditional HPLC over shorter testing time periods with higher sensitivity, but with significantly higher pressures (>10,000 psi). UHPLC systems are often operated as micro-scale, capillary-scale or nano-scale HPLC, with mobile phase flow rates in the range of about 100 nL/min to 100 μL/min and column inner diameters of between 25-1 1000 μm. Some, though not necessarily all, of the benefits that result in this reduction in size include reduced solvent consumption (both an environmental and economic benefit), increased sensitivity, reduced stationary phase usage, improved compatibility with mass spectrometry, and analysis of smaller sample quantities. Because stainless steel tubing of sufficient quality is typically unavailable in these dimensions, alternative materials such as fused silica may be used for column fabrication. However, such materials are fragile, flexible, and require special handling precautions.

One solution that has been proposed is a patterned substrate, or “chip” based design in which flow paths of desired dimensions are created within a substrate akin to an electrical equivalent such as a computer chip. The flow paths in a chip-based design are typically formed in the substrate through chemical etching, lithography, or CNC machining, and are usually provided with square, rectangular, D-shaped, trapezoidal, or other polygonal cross-sectional shapes. These non-circular cross-sectional shapes suffer from degraded performance from that which would be expected with a circular cross-sectional shape due to asymmetries in the flow field and non-uniform density of the packed stationary phase, particularly in “corners” or crevices of the non-circular cross-sections, resulting in broadening of the sample plug and the spreading of its associated components. Attempts to create circular cross-sectional flow paths has heretofore required matching respective semi-circular paths in two distinct substrate layers by aligning and bonding the layers with minimal to no misalignment, and free of gaps and crevices. This approach has not proven to be consistently feasible.

Conventional patterned flow paths also have the drawback of having abrupt directional changes within the substrate, such as 900 bends, which tend to frustrate consistent stationary phase column packing, and cause band-broadening in chromatographic applications. These abrupt directional changes often occur at an interface between substrate layers where mobile phase and sample is received from the chip inlet and/or delivered to the chip outlet.

### SUMMARY

According to one aspect a high-pressure fluid handling device. The high-pressure fluid handling device includes a housing, a tube, and a stationary phase medium. The housing includes a first component with a first interface surface and a second component with a second interface surface. The first and second components are securable to one another with the first and second interface surfaces in facing relationship with one another to form an interface therebetween. The housing includes a channel extending through the first component to and along the interface. The tube extends along the channel. The tube defines a lumen with a substantially circular cross-section having a lumen diameter equal to or less than 1000 um. The stationary phase medium is positioned in the lumen. The stationary phase medium is suitable to chromatographically separate compounds present in a liquid sample.

According to another aspect, a high-pressure fluid handling device. An inlet is configured to receive a liquid sample. A housing includes first component having a first interface surface and a channel extending through the first interface surface. The housing includes a second component having a second interface surface. The first and second components are securable to one another with the first and second interface surfaces in facing relationship with one another to form an interface therebetween. A tube is positioned within the channel of the first component. The tube defines a lumen with a substantially circular cross-section. A stationary phase medium is disposed within the lumen of the tube. The stationary phase medium is suitable to chromatographically separate compounds present in a liquid sample. An outlet port is fluidically coupled to the inlet port via the tube.

According to another aspect, a method of forming a high-pressure fluid handling device. A first component having a first interface surface is provided. A channel is etched into the first interface surface of the first component. A tube is positioned within the channel. The tube includes a lumen having a substantially circular cross-section with a diameter of less than or equal to 1000 um. A second component having a second interface surface is secured to the first component. The tube is packed with stationary phase medium. The stationary phase medium is suitable to chromatographically separate compounds present in a liquid sample.

### BRIEF DESCRIPTION OF THE DRAWINGS

FIG. 1 is an isometric view of a high-pressure fluid handling device, according to some embodiments.

FIG. 2 is a schematic view of a liquid chromatography system including a high-pressure fluid handling device, according to some embodiments.

FIG. 3 is an isometric view of a first component and a second component of a high-pressure fluid handling device, according to some embodiments.

FIG. 4 is an isometric bottom view of a first component and a second component of a high-pressure fluid handling device, according to some embodiments.

FIG. 5 is an isometric cross-sectional view of a high-pressure fluid handling device, according to some embodiments.

FIG. 6 is a magnified, isometric cross-sectional view of a radiused bend of a tube in a high-pressure fluid handling device, according to some embodiments.

FIG. 7 is a cross-sectional view of a tube and a channel extending through a high-pressure fluid handling device, according to some embodiments.

FIG. 8 is an isometric bottom view of a first component of a high-pressure fluid handling device, according to some embodiments.

FIG. 9 is a cross-sectional side view of a high-pressure fluid handling device with a tube terminating at an outlet on an outer surface of the high-pressure fluid handling device, according to some embodiments.

FIG. 10 is a cross-sectional side view of a multi-walled tube of a high-pressure fluid handling device, according to some embodiments.

FIG. 11A is a cross-sectional view of a high-pressure fluid handling device with a membrane placed over an outlet to form a cavity, according to some embodiments.

FIG. 11B is a cross-sectional view of a high-pressure fluid handling device with a stationary phase retained in the cavity, according to some embodiments.

FIG. 11C is a cross-sectional view of a high-pressure fluid handling device with the membrane removed to expose the cavity, according to some embodiments.

FIG. 11D is a cross-sectional view of a high-pressure fluid handling device with a porous frit installed within the cavity to retain the stationary phase inside the tube, according to some embodiments.

FIG. 12A is a chromatogram of a fluid handling device packed with a stationary phase at 1,500 psi, according to some embodiments.

FIG. 12B is a chromatogram of a fluid handling device packed with a stationary phase at 16,500 psi, according to some embodiments.

FIG. 13 is a flow chart of a method of forming a high-pressure fluid handling device, according to some embodiments.

FIG. 14 is a flow chart of a method for packing a tube of a high-pressure fluid handling device, according to some embodiments.

### DETAILED DESCRIPTION

The present disclosure describes a fluid handling device for use in liquid chromatography. The high-pressure fluid handling device comprises a housing having a small-diameter fluid passageway extending through the housing. The small-diameter fluid passageway is configured to withstand high-pressure (i.e., includes thick side walls and/or captured by the housing to support high-pressure loads). The small-diameter fluid passageway is configured for use on micro-scale, capillary-scale, and/or nano-scale liquid chromatography, with a cross-sectional diameter of equal to or less than 1000 μm. The small-diameter fluid passageway extends along a length of the high-pressure fluid handling device, such that the length of the small-diameter fluid passageway is at least 100 times the diameter of the small-diameter fluid passageway. The high aspect ratio (length-to-diameter) and/or the micro-scale/nano-scale diameter of the fluid passageway makes drilling a hole through the housing impractical.

To provide a small-diameter fluid passageway extending along a length of the high-pressure fluid handling device that is configured to withstand high-pressure loads, the housing includes a first component with a first interface surface and a second component with a second interface surface. The first and second components are secured together with the first and second interface surfaces in a facing relationship to form an interface therebetween. The housing includes a channel extending through the first component and along the interface. A tube defining a small-diameter fluid passageway having a substantially circular cross-section is positioned in the channel. The fluid passageway is packed with a stationary phase medium suitable for chromatographic separation of a liquid sample.

If, for example, the channel were to extend through both the first component and the second component (e.g., the first component including a semi-circular channel and the second component including a semi-circular channel), a near perfect alignment would be required between the first component and the second component. If the alignment is off by micrometers, sharp edges would be formed along the fluid passageway, corrupting the liquid chromatography process.

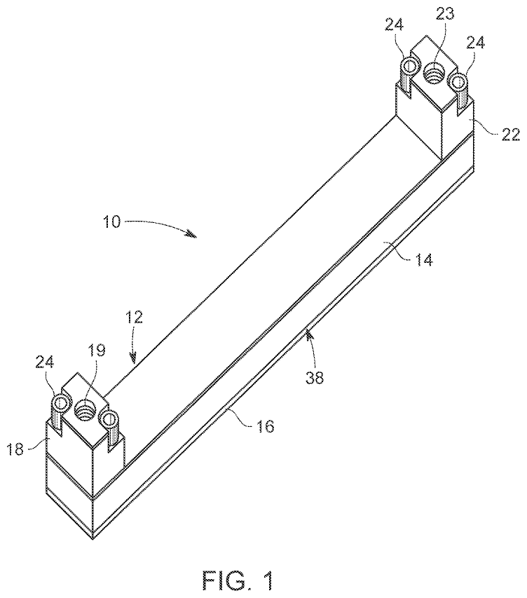

FIG. 1 is an isometric view of a high-pressure fluid handling device 10, according to some embodiments. The high-pressure fluid handling device 10 includes a housing 12 having a first component 14 and a second component 16 forming an interface 38 therebetween. The high-pressure fluid handling device 10 includes an inlet block 18 secured to the first component 14 and/or the second component 16 via one or more fasteners 24. The inlet block 18 includes an inlet tube receptacle 19 configured to receive a liquid sample and/or secure to an inlet tube (or a conduit) for transporting the liquid sample. The high-pressure fluid handling device 10 includes an outlet block 22 secured to the first component 14 and/or the second component 16 via one or more fasteners 24. The outlet block 22 includes an outlet tube receptacle 23 configured to output a liquid sample and/or secure to an outlet tube (or a conduit) for transporting the liquid sample. In some embodiments, the inlet and outlet tube receptacles 19, 23 are configured to engageably receive tube connecting hardware that may effectively establish a fluidic connection. Inlet and outlet tube receptacles may be threaded to threadably engage with tube connecting hardware.

The high-pressure fluid handling device 10 may be used in connection with a variety of fluid transfer applications. In some embodiments, the high-pressure fluid handling device 10 may be particularly well suited for liquid chromatography applications, such as high performance liquid chromatography (“HPLC”) and/or ultra-high performance liquid chromatography (“UHPLC”). For instance, the high-pressure fluid handling device 10 is configured to receive a liquid sample through the inlet block 18. The liquid sample travels through the high-pressure fluid handling device 10 and exits the high-pressure fluid handling device 10 through the outlet block 22. The high-pressure fluid handling device 10 may be referred to as a “chip” (for chip-based chromatography applications) or, more generically, a “manifold”.

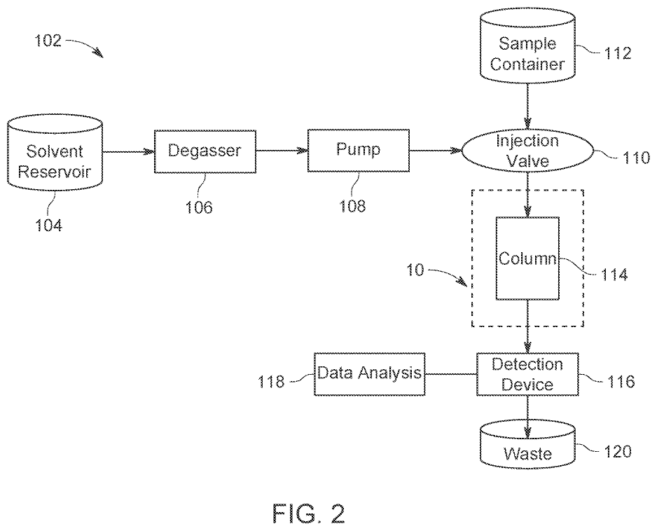

FIG. 2 is a schematic view of a high-pressure liquid chromatography system 102 including the high-pressure fluid handling device 10, according to some embodiments. The high-pressure liquid chromatography system 102 includes a solvent reservoir 104 (and/or eluent reservoir), a degasser 106 for degassing the liquid solvent/eluent, a pump, such as a high pressure pump 108, for pumping the degassed liquid solvent/eluent to an injection valve 110 where sample from a sample container or autosampler 112 is injected into the solvent/eluent stream and delivered to a column 114 for chromatographically separating the sample. The plug(s) of chromatographically separated sample may then be analyzed by a detection device 116, such as a mass spectrometer or ultraviolet/visible spectrum detector. Data analysis may be performed by a data acquisition instrument 118 such as a computer, and liquid waste may be collected in a waste reservoir 120.

In some embodiments, the high-pressure liquid chromatography system 102 optionally includes additional or different components, as is well known in the art, such as flow cells for optical analysis, in-line degassers, sample loops, etc. The high-pressure fluid handling device 10 described with reference to the drawing figures encompasses a portion of chromatographic system 102 between injection valve 110 and analytical instrument 116, according to some embodiments. The high-pressure fluid handling device 10 may contain, be comprised of, or integrate directly with additional elements without requirement for external tubes, which can include, but are not limited to, a flow cell for optical detection, a heating or cooling element to control temperature, and/or an emitter tip for use with mass spectrometry, according to some embodiments.

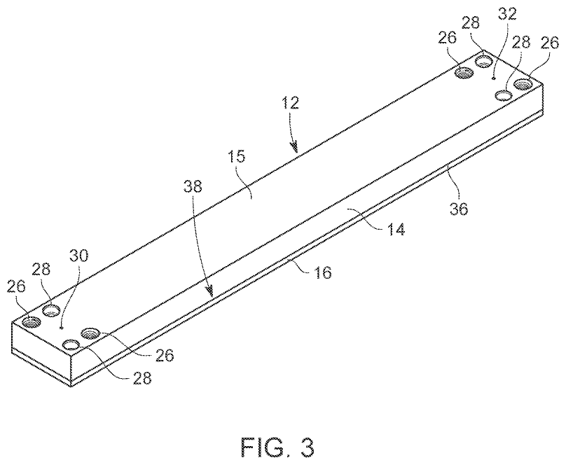

FIG. 3 is an isometric view of the first component 14 and the second component 16 of the high-pressure fluid handling device 10, according to some embodiments. The first component 14 includes an outer surface 15, an inlet opening 30, an outlet opening 32, one or more mounting receptacles 26, and one or more alignment features 28, according to some embodiments. The high-pressure fluid handling device 10 is configured to facilitate fluid-tight seals between an inlet tube (not shown) and the inlet opening 30, as well as between an outlet tube (not shown) and the outlet opening 32. In some embodiments, the inlet and outlet blocks 18, 22 are secured to the first component 14 in a manner that prevents fluid from escaping between the respective inlet and outlet block 18, 22 and the first component 14. Accordingly, the inlet and outlet tubes secured to respective inlet and outlet blocks 18, 22 with coupling hardware that prevents fluid leaks out from receptacles 19, 23 convey fluid (namely mobile phase) to the inlet opening 30 and from the outlet opening 32.

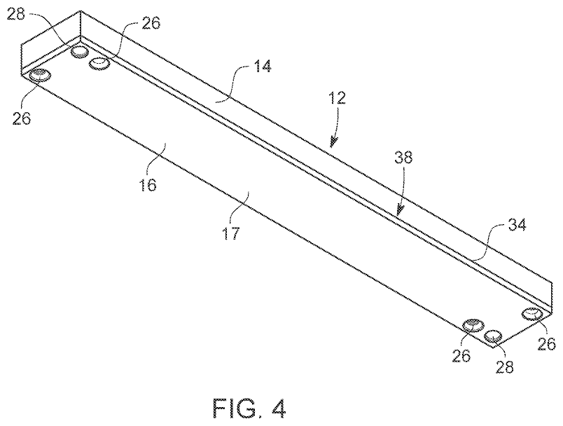

FIG. 4 is an isometric bottom view of the first component 14 and the second component 16 of the high-pressure fluid handling device 10, according to some embodiments. The second component 16 includes an outer surface 17, one or more mounting receptacles 26, and one or more alignment features 28, according to some embodiments. The one or more mounting receptacles 26 positioned on the first component 14 (as shown in FIG. 3) align with the one or more mounting receptacles 26 positioned on the second component 16. Likewise, the one or more alignment features 28 positioned on the first component 14 (as shown in FIG. 3) align with the one or more alignment features 28 positioned on the second component 16. In some embodiments, the one or more mounting receptacles 26 and/or one or more alignment features 28 extend through the first component 14 and the second component 16 of the housing 12 to align and secure the first component 14 and the second component 16 together. For instance, the fasteners 24 extend through the one or more mounting receptacles 26 to couple the first component 14 and the second component 16 together and a stud/pin (not shown) can extend through the one or more alignment features 28 to align the first component 14 relative to the second component 16.

In some embodiments, the first component 14 and the second component 16 can be aligned and fastened together without mounting receptacles 26 and/or alignment features 28. For instance, the forces required to maintain a fluid-tight seal are provided by external means (not shown), e.g., a clamping mechanism. In this or other embodiments, the high-pressure fluid handling device 10 may be configured to facilitate fluid-tight seals directly between adjacent components of chromatography system 102, for instance, between the high-pressure fluid handling device 10 and the injection valve 110 and/or between the high-pressure fluid handling device 10 and the detection device 116, with or without the use of one or more of inlet and outlet tubes.

The isometric bottom view of FIG. 4 shows the outer surface 17 of the second component 16. Although FIGS. 3-4 show the housing 12 including the first and second components 14, 16, the housing 12 may comprise several layers of the same or different materials to form the overall “chip” or “manifold” of the high-pressure fluid handling device 10. For the purposes of this application, the housing 12 may be constructed to define the interface 38 between two interfacial surfaces. In the illustrated embodiment, each of first and second components 14, 16 include a respective interface surface, with first component 14 including a first interface surface 34, and second component 16 including a second interface surface 36. The first and second interface surfaces 34, 36 engage (or abut) each other at the interface 38.

In some embodiments, the first component 14 and the second component 16 are securable to one another with the first interface surface 34 and the second interface surface 36 in a facing relationship with one other to form the interface 38. For instance, the first and second components 14, 16 are securable to one another with the first interface surface 34 engaged with the second interface surface 36 to retain the tube 40 therebetween and to maintain an overall integrity of the fluid handling device 10. The engagement between the first interface surface 34 and the second interface surface 36 is configured to avoid misalignment between the first and second components 14, 16. In some embodiments, the alignment features 28 pass through the entirety of the housing 12 and minimize/eliminate gaps or sharp features between the first interface surface 34 and the second interface surface 36. In some embodiments, the first interface surface 34 and the second interface surface 36 are secured together via brazing, laser welding, adhesives, mechanical fastening, etc.

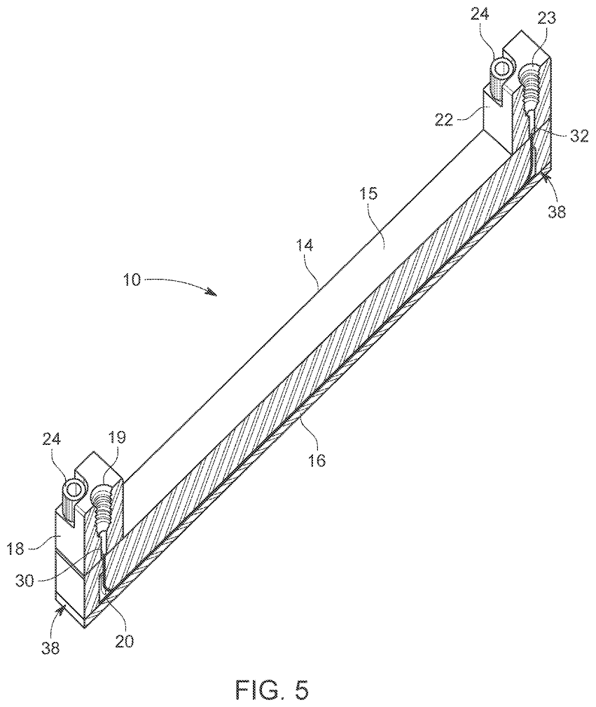

FIG. 5 is an isometric cross-sectional view of the high-pressure fluid handling device 10, according to some embodiments. The high-pressure fluid handling device 10 includes a channel 20 extending through the first component 14 between the inlet opening 30 and the outlet opening 32, according to some embodiments. The channel 20 is positioned at the outer surface 15 of the first component 14 at the inlet port 30 and the outlet port 32. The channel 20 extends through the first component 14 from the outer surface 15 to the interface surface 34, in some embodiments. The channel 20 is positioned along the interface surface 34, and in some embodiments, the channel 20 is formed via milling, cutting, laser etching, chemical etching, lithography, CNC machining, etc., of the interface surface 34. In other embodiments, the first housing 14 is formed via a mold or extrusion with the channel 20 formed in the mold/extrusion. In the illustrated embodiment, the channel 20 is formed solely in first component 14 (not through the second component 16), though it is contemplated that the channel 20 may be formed in one or more layers of the high-pressure fluid handling device 10. The channel 20 may form one or more of a through-bore through at least one of the first and second components 14, 16, and/or a recess or groove in a surface of one or more of the first and second components 14, 16.

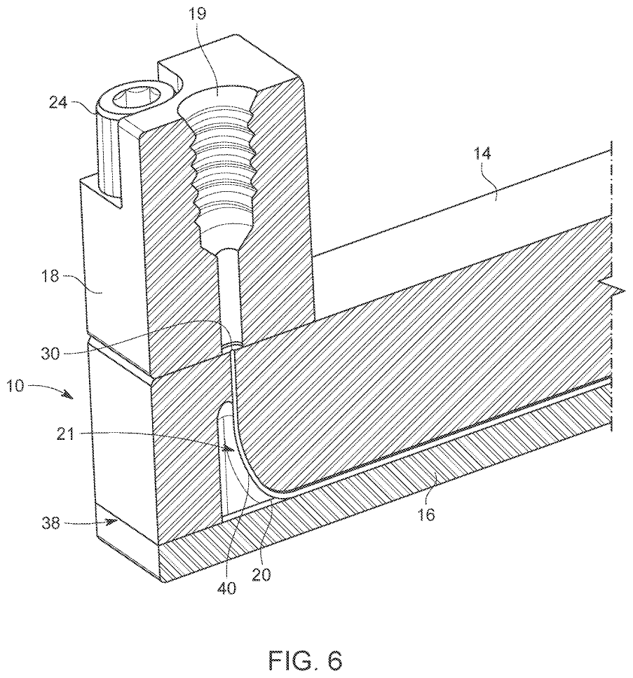

FIG. 6 is a magnified, isometric cross-sectional view the high-pressure fluid handling device 10, according to some embodiments. The high-pressure fluid handling device 10 includes a tube 40 positioned within the channel 20 and a radiused bend 21 of the channel 20. The tube 40 is positioned within the channel 20 of the high-pressure fluid handling device 10 to extend through and/or along one or more of the first and second components 14, 16. In some embodiments, the tube 40 extends from the inlet opening 30 to the outlet opening 32. In doing so, tube 40 extends along the channel 20 through the first component 14 and along the interface 38.

The radiused bend 21 of the channel 20 is configured to transition the position of the channel 20 from the outer surface 15 to the interface surface 34 without sharp edges or abrupt directional changes that would disrupt fluid flow characteristics. In some embodiments, the radiused bend 21 may be between 5° and 180°, with the illustrated embodiment having the radiused bend 21 of 90°. In some embodiments, radiused bend 21 may be between 60° and 120°.

In some embodiments, the tube 40 is fabricated from materials, and formed into configurations capable of establishing and maintaining the lumen diameters described below, including while following one or more radiused bends 21. In some embodiments, the tube 40 is fabricated from a biocompatible material such as, for example, stainless steel, titanium, poly ether-ether ketone, and combinations thereof, for example, poly-ether-ether-ketone lined stainless steel tubing. Other metal, metal alloy, polymeric materials, and combination materials are contemplated as being useful in the manufacture of the tube 40 as well as coated versions of the tube 40 where a coating has been applied to one or more surfaces of the tube 40, imparting beneficial properties, for example, chemical compatibility, bio-inertness, etc.

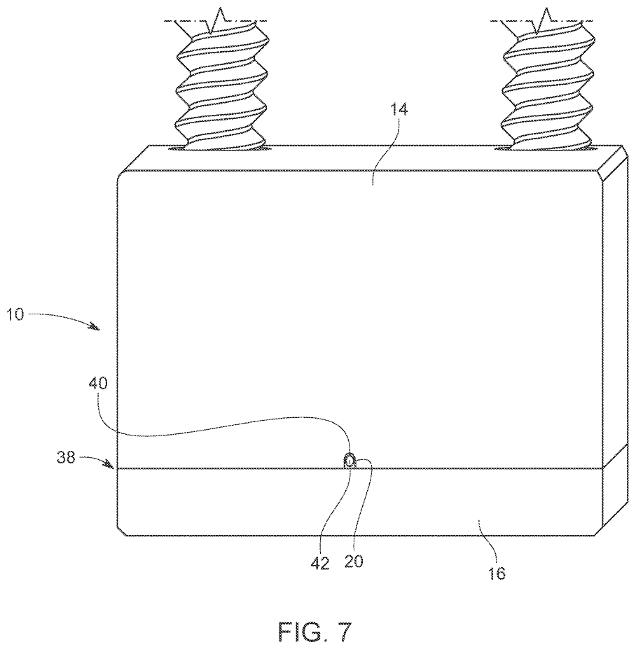

FIG. 7 is a cross-sectional view of the tube 40 and the channel 20 extending through the high-pressure fluid handling device 10, according to some embodiments. The tube 40 defines a lumen 42. In some embodiments, the lumen 42 has a substantially circular cross-sectional configuration. In some embodiments, the lumen 42 has a circular cross-section, wherein diameter dimensions along orthogonal radial axes in the lumen 42 are within 5% of one another, preferably within 3% of one another, and still more preferably within 2% of one another. In this manner, the precise configuration of the channel 20 is unimportant, so long as the tube 40 is positioned in channel 20 to provide a desired fluidic connection. As described above, a circular cross-sectional arrangement for the fluid passageway is most desirable because it facilitates expected and reproducible flow patterns and effects on the sample-bearing eluent. Thus, the tube is configured to maintain a substantially circular lumen cross-section when disposed in channel 20.

In some embodiments, the lumen 42 defines a micro-scale, capillary scale, and/or nano-scale diameter configured for use in HPLC and/or UHPLC. The lumen 42 has a lumen diameter of less than or equal to 1000 μm, according to some embodiments. In some embodiments, the lumen 42 has a lumen diameter of between 25-1000 μm, in some embodiments, the lumen 42 has a lumen diameter of between 25-500 μm, in some embodiments, the lumen 42 has a lumen diameter of between 25-250 μm, and/or in some embodiments, the lumen 42 has a lumen diameter of between 25-150 μm.

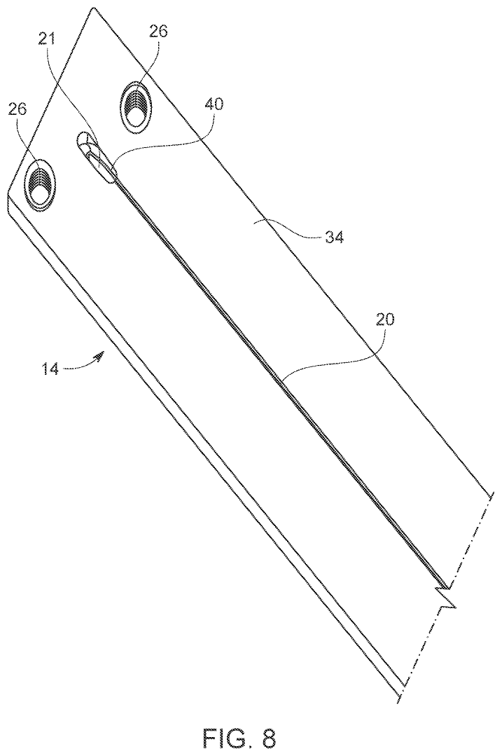

FIG. 8 is an isometric bottom view of the first component 14 of the high-pressure fluid handling device 10, according to some embodiments. The first component 14 includes the interface surface 34 with the channel 20 formed therein. The tube 40 is positioned within the channel 20. In some embodiments, the tube 40 is brazed into the channel 20. For instance, the tube 40 is brazed into the channel 20 such that gaps between the tube 40 and the channel 20 are filled with brazing metal. In other embodiments, the tube 40 is secured to the channel 20 with adhesive whereby gaps between the tube 40 and the channel 20 are filled with adhesive.

In some embodiments, the channel 20 is formed entirely in the first component 14. In other words, the interface surface 36 of the second component 16 does not include a recess or channel which forms part of the channel 20. For instance, as illustrated in FIG. 7, the interface surface 36 of the second component 16 is planar. In some embodiments, the tube 40 is disposed entirely within the channel 20 in first component 14. In other words, no portion of the tube 40 extends within a recess, channel, or other concave features of the second component 16.

In some embodiments, positioning the channel 20 solely at the first component 14 (and not in the second component 16) is beneficial because it does not require perfect alignment between the first component 14 and the second component 16. For example, if the channel 20 extended through both the first component 14 and the second component 16 (e.g., the first component 14 including a semi-circular channel and the second component 16 including a semi-circular channel), a near perfect alignment would be required between the first component 14 and the second component 16. If the alignment is off by micrometers, sharp edges would be formed along the fluid passageway, interfering with the liquid chromatography process. Therefore, positioning tube 40 solely in the first component 14 provides a substantially circular flow path without requiring near-perfect alignment along the entire length of the high-pressure fluid handling device 10.

In some embodiments, positioning the tube 40 between the first component 14 and the second component 16 is beneficial because the first component 14 and the second component 16 provide structural support for the side walls of the tube 40. The flow path of the high-pressure fluid handling device 10 may need to withstand high pressure (e.g., pressure between 1,500 and 16,500 psi and/or pressures in the 20,000 psi range). The first component 14 and the second component 16 abut the tube 40 and provide the structural support necessary to withstand the high pressures (e.g., in the 20,000 psi range) of HPLC and UHPLC systems.

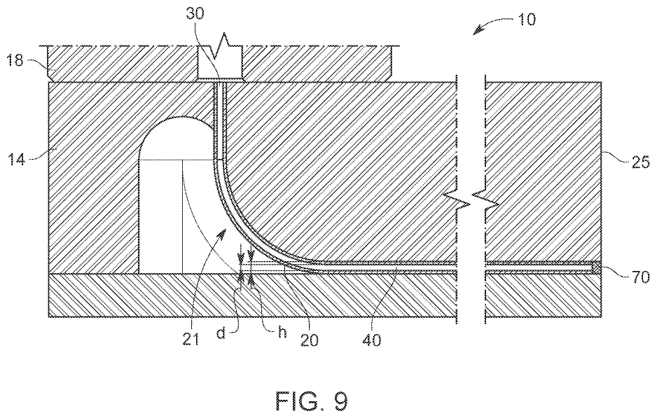

FIG. 9 is a cross-sectional side view of the high-pressure fluid handling device 10 with the tube 40 terminating at an outlet 70 at an outer surface 25 of the high-pressure fluid handling device 10, according to some embodiments. The high-pressure fluid handling device 10 includes the outlet 70 positioned on an outer surface 25 of the housing 12. Furthermore, it will be readily understood by those skilled in the art that the channel 20 may originate at any face of the housing 12 and/or may terminate at any face of the housing 12, and that in some embodiments, the faces of origination and termination may be the same face.

In some embodiments, the tube 40 includes a diameter d and the channel 20 includes a height (or depth) h. The height h of the channel 20 is greater than or equal to the diameter d of the tube 40. This configuration is beneficial, as the tube 40 is configured to be received within the channel 20 positioned solely on the first component 14. In other words, the channel 20 does not extend beyond the interface surface 36 of the second component 16 and/or no portion of the tube 40 is received within a feature of the second component 16.

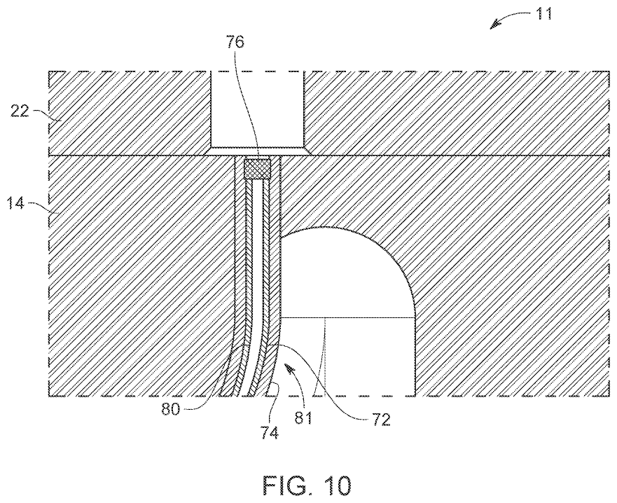

FIG. 10 is a cross-sectional side view of a multi-walled tube 80 of the high-pressure fluid handling device 11, according to some embodiments. The high-pressure fluid handling device 11 includes any and/or all features of the high-pressure fluid handling device 10 described above, according to some embodiments. The multi-walled tube 80 includes an interior wall 72 and an exterior wall 74, according to some embodiments. In some embodiments, the multi-walled tube 80 is fabricated from a biocompatible material such as, for example, stainless steel, titanium, poly ether-ether ketone, and combinations thereof, for example, poly-ether-ether-ketone lined stainless steel tubing. Other metal, metal alloy, polymeric materials, and combination materials are contemplated as being useful in the manufacture of the multi-walled tube 80 as well as coated versions of the tube 80 where a coating has been applied to one or more surfaces of the multi-walled tube 80, imparting beneficial properties, for example, chemical compatibility, bio-inertness, etc. Furthermore, it will be readily understood by those skilled in the art that the multi-walled tube 80 may include any number of layers and/or materials. In some embodiments, an outlet frit 76 is positioned within the multi-walled tube 40 to prevent a stationary phase material from exiting the high-pressure handling device 10. In some embodiments, the exterior wall 74 is formed of a brazing metal filling a gap between the tube 40 and the channel 20. The multi-walled tube 80 is configured to be positioned on a radiused bend 81, according to some embodiments.

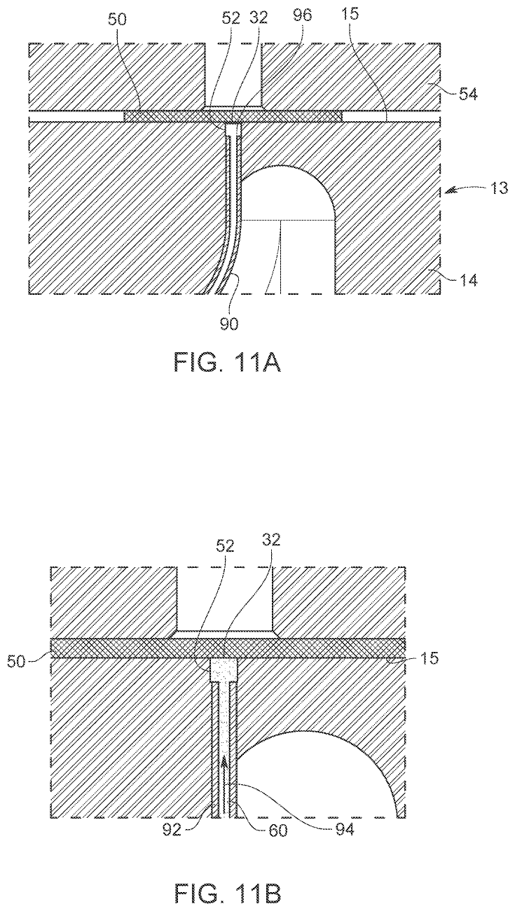

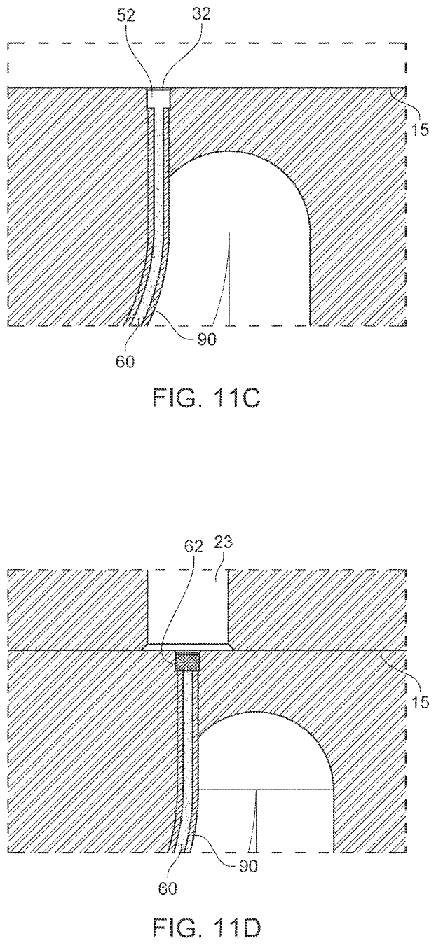

FIGS. 11A-D are cross-sectional views which show an exemplary embodiment of filling (or “packing”) a stationary phase 60 within a lumen 92, according to some embodiments. For instance, FIG. 11A is a cross-sectional view showing a filter 50 placed over the outlet opening 32 and secured to the housing 12 for the purpose of packing the lumen 92. The filter 50 is impermeable to the stationary phase (not shown in FIG. 11A), i.e., the filter 50 includes pores smaller than a particle size of the stationary phase. The filter 50 is configured to allow fluid (i.e. a liquid packing slurry) to permeate through the filter 50 as the stationary phase 60 is packed and retained in the tube 90. The high-pressure fluid handling device 10 includes a cavity 52 positioned adjacent to outlet 32, and between an end 96 of the tube 90. In some embodiments, the tube 90 does not extend to the outer surface 15 of the first housing 14, and instead, the cavity 52 is formed in the space between the tube 40 and the outer surface 15 (within the channel 20).

FIG. 11B shows a lumen 92 of the tube 90 filled with the stationary phase 60, according to some embodiments. The stationary phase 60 is pressure-driven into the lumen 92 of the tube 90 through the inlet 30 (not shown in FIG. 11B) and fills the lumen 42. The stationary phase 60 is urged from the inlet 30 (not shown in FIG. 11B) to the outlet 32, i.e., in a flow path direction as indicated by arrow 94. In some embodiments, the filter 50 and/or the block 54 positioned on the outer surface 15 of the first housing 14 enable the high packing pressure by preventing the escape of the stationary phase through the outlet 32, even under high pressure. The cavity 52 is filled with the stationary phase 60.

In some embodiments, the stationary phase 60 is packed into lumen 92 at a pressure between 1,500 and 20,000 psi. As will be recognized by those skilled in the art, performance improvements of HPLC and/or UHPLC may result from higher packing pressures which requires a commensurately higher pressure capability. A conventional stationary phase packing may pack the stationary phase into the lumen 92 at between 1,500 and 2,000 psi. However, stationary phase packing performed at between 10,000 and 20,000 psi may yield better separation results. In some embodiments, positioning the filter 50 at the outlet enables a higher packing pressure of the stationary phase 60, as the semi-permeable filter 50 retains the stationary phase 60 in the lumen 92 while the stationary phase 60 is packed at high-pressure (e.g., at pressure between 5,000 and 20,000 psi).

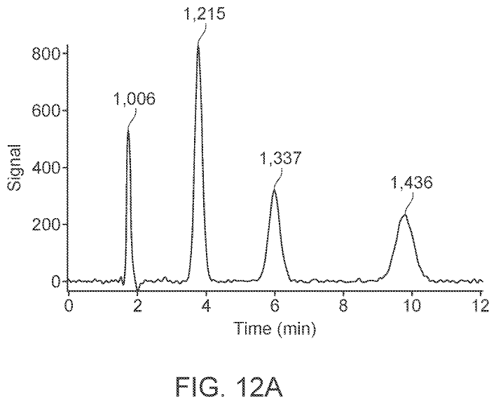

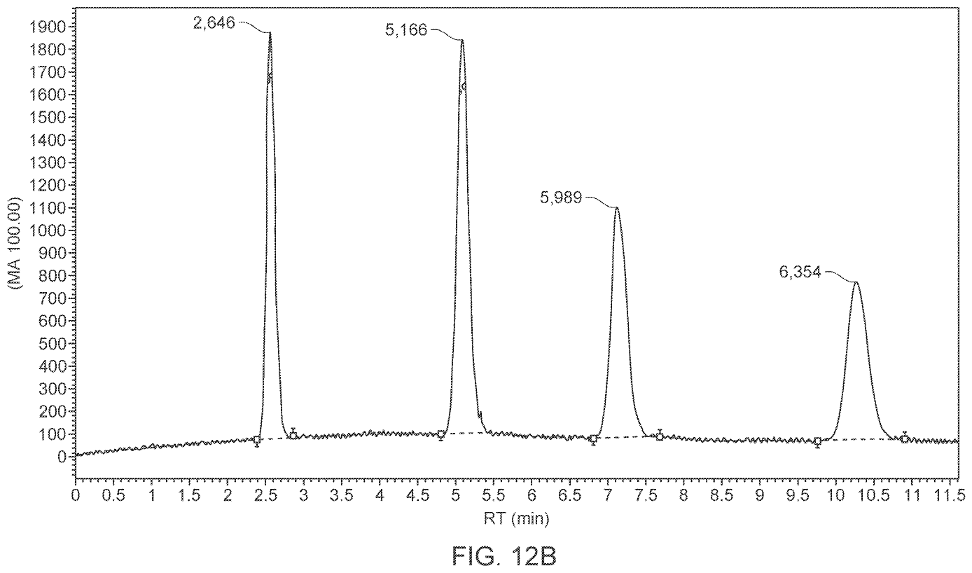

For instance, FIGS. 12A and 12B illustrate chromatograms obtained under similar conditions through fluid handling device 10 having a tube length of 150 mm and a lumen diameter of 200 μm. The chromatograms illustrate the separation of thiourea, acetophenone, propiophenone, and butyrophenone in 45%ACN:55%H2O at 2 μl/min using 2.7 μm superficially porous 160 Å C 18 stationary phase. FIG. 12A shows the results for the stationary phase packed at 1,500-2,000 psi, while FIG. 12B shows the results for the stationary phase packed at 16,500 psi. The significantly higher theoretical plate counts of FIG. 12A as compared to FIG. 12B demonstrate the improved chromatographic performance achievable through higher stationary phase packing pressures, which are facilitated through the packing technique described herein.

FIG. 11C shows the filter 50 removed from the outer surface 15, according to some embodiments. Removing the filter 50 (and the block 54) exposes the cavity 52 which allows visual inspection of the outlet 32 to verify if the stationary phase 60 is present at the outlet 32. In some embodiments, the stationary phase 60 is removed from the cavity 52 following removal of the filter 50.

FIG. 11D shows a porous frit 62 (i.e. or porous plug) installed into the cavity 52 to retain the stationary phase 60 within the tube 90, according to some embodiments. The porous frit 62 is impermeable for the stationary phase but permeable for the liquid sample and/or liquid solvent (or eluent). In some embodiments, the porous frit 62 is made from stainless steel, titanium, stainless steel-nickel alloy and/or poly ether-ether ketone. It will be readily apparent to those skilled in the art that the arrangement illustrated in FIGS. 11A-D may also apply in conjunction with or separately from an inlet, for example, the inlet 30.

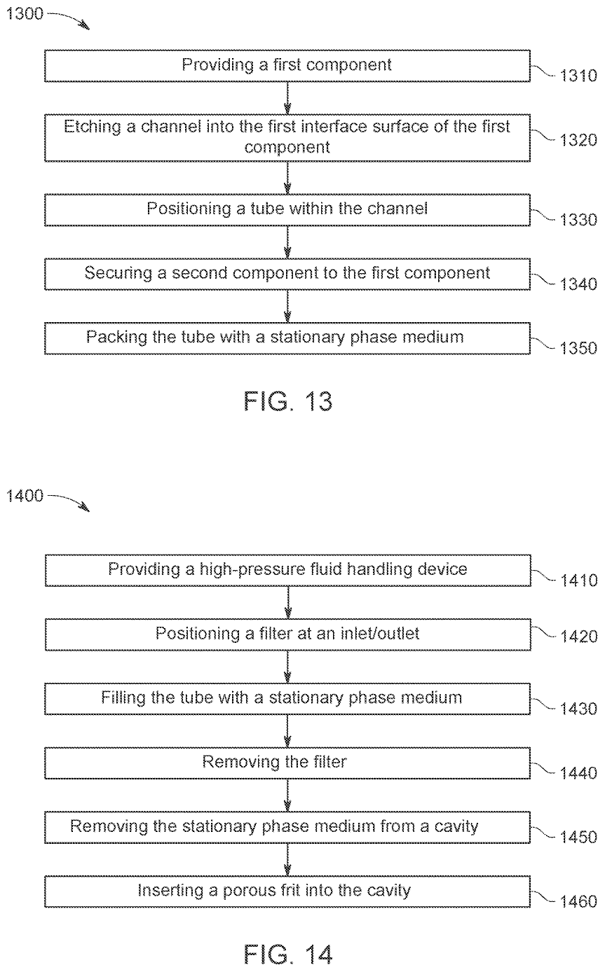

FIG. 13 is a flow chart of a method 1300 of forming a high-pressure fluid handling device, according to some embodiments. At step 1310, the method 1300 includes providing a first component. The first component includes any and/or all features of the first component 14 described above in any of FIGS. 1-11D.

At step 1320, the method 1300 includes forming a channel into the first interface surface of the first component. The channel includes any and/or all features of the channel 20 described above. In some embodiments, etching the channel 20 includes any of a variety of known techniques, including laser etching, chemical etching, lithography, CNC machining, etc.

At step 1330, the method 1300 includes positioning a tube within the channel. The tube includes any and/or all features of the tube 40 described above. In some embodiments, the tube 40 is positioned entirely within the channel 20. In other words, a depth of the channel 20 is greater than or equal to an outer diameter of the tube 40 such that the tube 40 is positioned entirely within the first component 14. In some embodiments, the second interface surface 36 is substantially planar and the tube 40 does not intersect the substantially planar second interface surface 36. In some embodiments, the step 1330 includes brazing the tube 40 into the channel 20 such that gaps between the tube 40 and the channel 20 are filled with brazing metal. In some embodiments, the step 1330 includes filling the gaps between the tube 40 and the channel 20 with epoxy resin and/or other adhesive or brazing materials.

At step 1340, the method 1300 includes securing a second component having a second interface surface to the first component. The second component includes any and/or all features of the second component 16 described above. In some embodiments, the first component 14 is secured to the second component 16 via the fasteners 24 and/or the alignment features 28. In some embodiments, the first component 14 is secured to the second component 16 via brazing, welding, clamping, etc.

At step 1350, the method 1300 includes packing the tube with a stationary phase medium. The stationary phase medium includes any and/or all features of the stationary phase 60 described above. In some embodiments, the stationary phase 60 is packed into lumen 42 at a packing pressure of at least 1,500 psi. In some embodiments, the stationary phase 60 is packed into lumen 42 at a packing pressure of at least 2,000 psi. In some embodiments, the stationary phase 60 is packed into lumen 42 at a packing pressure of at least 5,000 psi. In some embodiments, the stationary phase 60 is packed into lumen 42 at a packing pressure of at least 10,000 psi. In some embodiments the stationary phase 60 is packed into lumen 42 at a packing pressure of between 10,000 and 20,000 psi. For the purposes hereof, the term “packing pressure” means the fluid pressure driving the stationary phase 60 into lumen 42. In some embodiments, the fluid pressure is a pressure of a liquid packing slurry. In some embodiments, the liquid packing slurry may be pressurized via a pressurized gas volume. As will be recognized by those skilled in the art, performance improvements of HPLC and/or UHPLC may result from higher packing pressures which requires a commensurately higher pressure capability.

FIG. 14 is a flow chart of a method 1400 for packing a tube of a high-pressure fluid handling device, according to some embodiments. In some embodiments, the method 1300 includes any and/or all of the steps, features, or processes shown and described in reference to FIGS. 11A-D. At step 1410, the method 1400 includes providing a high-pressure fluid handling device. The high-pressure fluid handling device includes any and/or all features of the high-pressure fluid handling device 10 described above and in FIGS. 1-11D.

At step 1420, the method 1400 includes positioning a filter at an inlet and/or an outlet. The inlet/outlet includes any and/or all features of the inlet 30 and the outlet 32 described above. The filter (e.g., the filter 50) can be positioned on the outer surface 15 to provide an impermeable membrane for a stationary phase medium. At step 1430, the method 1400 includes filing the tube with the stationary phase medium. In some embodiments, the stationary phase 60 is packed into lumen 42 of the tube 40 at a pressure between 1,500 and 20,000 psi. As will be recognized by those skilled in the art, performance improvements of HPLC and/or UHPLC may result from higher packing pressures which requires a commensurately higher pressure capability.

At step 1440, the method 1400 includes removing the filter from the inlet/outlet. The filter 50 can be removed from the outer surface 15 thereby exposing the inlet 30 and/or the outlet 32 to allow visual verification of whether the stationary phase 60 is present. At step 1450, the stationary phase medium is removed from a cavity. In some embodiments, the stationary phase 60 is removed from the cavity 52 following removal of the filter 50. At step 1460, a porous frit (or filter) is inserted into the cavity. In some embodiments, a porous frit 62 is installed into the cavity 52 to retain the stationary phase 60 within the tube 40. The porous frit 62 is impermeable for the stationary phase 60 but permeable for the liquid sample and/or liquid solvent (or eluent).

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A high-pressure fluid handling device, comprising:
a housing having a first component with a first interface surface and a second component with a second interface surface, wherein the first and second components are securable to one another with the first and second interface surfaces in facing relationship with one another to form an interface therebetween, the housing having a channel extending through the first component to and along the interface;
a tube extending along the channel, the tube defining a lumen with a substantially circular cross-section having a lumen diameter equal to or less than 1000 μm; and
a stationary phase medium in the lumen, wherein the stationary phase medium is suitable to chromatographically separate compounds present in a liquid sample.

2. The high-pressure fluid handling device of claim 1, wherein the first and second components are securable to one another with the first and second interface surfaces sealingly engaged.

3. The high-pressure fluid handling device of claim 1, wherein the channel forms an inlet opening and an outlet opening in the first component.

4. The high-pressure fluid handling device of claim 3, wherein the tube extends from the inlet opening to the outlet opening.

5. The high-pressure fluid handling device of claim 1, wherein the tube is sealingly engaged to a wall of the first component defining the channel, preventing liquid from passing between the tube and the wall.

6. The high-pressure fluid handling device of claim 1, wherein the channel includes a radiused bend of between 5° and 180°.

7. The high-pressure fluid handling device of claim 6, wherein the tube follows the radiused bend.

8. The high-pressure fluid handling device of claim 1, wherein the tube is a biocompatible material.

9. The high-pressure fluid handling device of claim 8, wherein the tube is selected from stainless steel, titanium, stainless steel-nickel alloy, poly ether-ether ketone, and combinations thereof.

10. The high-pressure fluid handling device of claim 3, including a porous plug disposed in proximity to at least one of the inlet opening and the outlet opening, wherein the porous plug is between the tube and the at least one of the inlet opening and the outlet opening, wherein the porous plug comprises one or more of stainless steel, titanium, stainless steel-nickel alloy, and poly ether-ether ketone.

11. A high-pressure fluid handling device, comprising:
an inlet configured to receive a liquid sample;
a housing including:
a first component having a first interface surface and a channel extending through the first interface surface, and
a second component having a second interface surface, wherein the first and second components are securable to one another with the first and second interface surfaces in facing relationship with one another to form an interface therebetween;
a tube positioned within the channel of the first component, the tube defining a lumen with a substantially circular cross-section;
a stationary phase medium disposed within the lumen of the tube, wherein the stationary phase medium is suitable to chromatographically separate compounds present in the liquid sample; and
an outlet port fluidically coupled to the inlet port via the tube.

12. The high-pressure fluid handling device of claim 11, wherein a depth of the channel is greater than or equal to an outer diameter of the tube.

13. The high-pressure fluid handling device of claim 12, wherein the tube is contained entirely within the channel of the first component.

14. The high-pressure fluid handling device of claim 13, wherein the second interface surface is substantially planar, wherein the tube does not intersect the substantially planar second interface surface.

15. The high-pressure fluid handling device of claim 13, wherein the substantially circular cross-section of the tube has a diameter of less than or equal to 1000 μm.

16. The high-pressure fluid handling device of claim 15, wherein the tube includes a length, wherein a ratio of the length to the diameter is greater than or equal to 100:1.

17. The high-pressure fluid handling device of claim 11, wherein a gap between the channel and the tube is filled with one or more of an epoxy resin, an adhesive material, and a brazing material.

18. A method of forming a high-pressure fluid handling device, comprising:
providing a first component having a first interface surface;
forming a channel into the first interface surface of the first component,
the channel fluidically connecting an inlet opening of the first component to an outlet opening of the first component;
positioning a tube within the channel, the tube including a lumen having a substantially circular cross-section with a diameter of less than or equal to 1000 μm;
securing a second component having a second interface surface to the first component;
positioning a filter at one of the inlet and outlet openings
packing the lumen with stationary phase medium with a packing pressure of at least 5,000 psi, wherein the stationary phase medium is suitable to chromatographically separate compounds present in a liquid sample, and wherein the filter is impermeable to the stationary phase medium.

19. The method of claim 18, including positioning a porous plug between the tube and one of the inlet opening and the outlet opening.

20. The method of claim 19, including positioning the porous plug prior to packing the lumen with the stationary phase medium.

21. The method of claim 19, including positioning the porous plug subsequent to packing the lumen with the stationary phase medium.
